(19) United States
(12) Patent Application Publication
(10) Pub. No.: US 2007/0234266 A1
(43) Pub. Date: Oct. 4, 2007

(54) Method of optimizing IC logic performance by static timing based parasitic budgeting

(76) Inventors: Chao-Chiang Chen, Cupertino, CA (US); J. George Janac, Cupertino, CA (US)

Correspondence Address: RONALD CRAIG FISH, P.O. BOX 820, LOS GATOS, CA, 95031, US

(21) Appl. No.: 10/774,853

(22) Filed: Feb. 7, 2004

(51) Int. Cl. G06F 17/50

(52) U.S. Cl. 716/13

(57) ABSTRACT

Increasing need to gain higher performance and lower power in semiconductor chips and field programable gate arrays requires that optimization be done in a constructive manner with respect to physical layout. Increasing perfomance by parasitic budgeting which dictates what parasitics are acceptable to meet timing and power goals is presented. Providing these controls allows the physical implementation system to skew connection parasitics in a way that makes critical components and their connections significantly faster then those in the rest of the circuit. This represent a unique advantage of existing methods and provide a unique methods to reach higher levels of performance and lower power then existing approaches.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The present invention relates to integrated circuit, and field programable logic circuit design tools. In particular the invention relates to the optimization of a gate level netlist for timing and power starting from a gate level representation of from a language based description of a circuit. The logic level circuit (netlist or language) must be mapped on to a specific library with specific size, parasitic, timing and power characteristics subject to contraints imposed on the circuit. Constraints imposed on the circuit maybe the clock frequency, timing arrival and required times, timing exceptions, dynamic power limits, static (leakage) power limits. Performance of the circuit is dictated by the initial logic architecture and the characteristics of the connections and parasitics) between components of library elements (cells) connected together to form the circuit. Circuit performance of connections (nets or wires which are formed as conductive paths on an integrated circuit) is dictated by process, layout style, topology and has a large effect on the final achivable result for size, timing, power, etc. Longer connections (wires) lead to slower library element (cell) performance and higher power. Optimization of circuits has been done in the prior art in a trial and error method of changing logic elements (cells) and/or changing connections (wires) in an attempt to satisfy the constraints. Connection length (wire length) leads to resistance, capacitance, and inductance parasitics. In the following discussion connection length and parasitics are used interchangeably.

### SUMMARY OF THE INVENTION

The present invention comprises an innovative method of evaluating each wire or net in a circuit multiple times assuming different connection lengths (parasitic capacitance load caused by the wire at that length) in order to determine what length for each wire, if satisfied by the layout system, will cause the circuit to meet constraints of timing and power. The result is a new netlist and a constraints file with the wires in the circuit organized in the constraints file into groups of different lengths, the length for each wire being the maximum length that wire can have in the circuit in the final layout for the circuit to meet timing and power constraints imposed by the designers.

By applying this method, critical paths (collections of components and connections that have a difficult time meeting goals) can achieve very small connection lengths (or parasitics), while non-critical paths can be laid out by the place and router tool so as to have longer connection lengths without violating constraints. We call this required restraints on connection lengths (or parasites) for various wires a parasitic budget. The parasitic budget is then used in the process of layout, placement, partitioning, and optimization.

Connection length in this context is used as a proxy for wire parasitics. Parasitics represent the resistance, capacitance, and inductance of a wire computed from its length, topology and surroundings in the circuit. The result of this connection length restraint evaluation for each wire in the circuit is a set of contraints which can be passed to the physical design system for placement, layout and routing. The constraints do not have to be honored by the prior art placement and routing tools, but the constraints are used as weighting factors to be considered by the placement and routing tools. This results in skewing of the placement and routing results toward wire lengths for each wire which tend to be closer to the lengths that cause the circuit's restraints to be met than would otherwise be the case if no constraints were input to the placement and router tool. The skewing that results in the placement and routing process results in having critical path wires which have much lower connection lengths than other wires, which produces faster, lower power, etc circuits than prior art methods.

The fundamental process of the invention is to evaluate all the wires in a circuit iteratively under various assumed connection lengths (or parasitics). A step size for incrementation between iterations is chosen which can be any value, but typically is the length or corresponding parasitic capacitance of a wire that has the minimum length needed to connect from a node on one row of the circuit layout to a node on an adjacent row of the circuit layout. Each level of evaluation is carried out by the Parasitic Stepping Engine. There are various methods of generating the steps described in this method. The basis of the invention is the iterative method using these steps to compute the parasitic budget.

The iterative method results in a set of connection lengths (or parasitics) which, when met by layout, will satisfy the timing and power constraints for the design or in a conclusion that the design will not work. This parasitic budget determination represents a novel way to determine acceptable parasitics, and library components, and the enforcement of these in the layout to meet performance.

Static timing (a prior art process of evaluating the performance of a circuit given its physical characteristics such as wire length, drive current levels, etc.) is used during each iteration of the process of the invention to evaluate the circuit. Thus the Static Timing Process is used multiple times, once at each iteration of connection lengths (or parasitics) for the wires being evaluated. Levels of length are dictated by layout, input capacitance of the next state, etc. A parasitic level is set for all the wires in the design, and then Static Timing is peformed to evaluate (at the particular connection length or parasitic value) how close to the constraints the circuit will come. Adjustment of the circuit (library cells) components in order to meet, or exceed, constraints at each level of connection length (or parasitic) is done first to attempt to meet constraints. Adjustments of components are made by methods of re-buffering, IPO (In-place optimization such as substituting a cell that does the same function but has a higher output drive current), or re-synthesis (re-designing the logic altogether). At each level connection length (or parasitic), after each component adjustment, critical path connection components (cells) and connections (wires) that fail are determined. The ones that fail have their wires lengths fixed at the acceptable connection length (or parasitic) that will cause the critical path to not fail. Usually, this is the next shorter connection length in the iterations where the critical path to not fail its constraints. Thereafter, the length of the wires that have failed and have been fixed at a length which does not fail remain fixed at the length which does not fail for rest of the analysis. This fixed length for a wire which has failed and which has been adjusted in length to a length which does not fail, represents the maximum allowable parasitic budget for that wire, after component adjustment has been carried out to attempt to meet the constraint. This length constraint for each wire so fixed must be met or exceeded (the fixed length of the constraint or shorter) by the placement and router tool during the final layout of the circuit in order to meet the design constraints.

If the circuit cannot meet the performance constraints with the connections (or parasitics) being of zero length (wire capacitance zero), then the circuit will never meet its constraints and must be re-designed. This represents a non feasible implementation.

As connection length (or parasitics) are increased, connection parasitics approach the level of the input loading of the next stage of gates. We call this the point where connection (or parasitic) effects are less than or equal to the input parasitic capacitance of the next stage (i.e, non-wire dominated). Layout in this area must be done with care as connections must be short and well clustered (cells that have to send signals to each other are placed close together on the chip). If most connections are in this region, the circuit may be difficult to implement in layout.

As connection lengths are increased, the zone of connection (or parasitic) dominated performance is reached. Connections which fail to meet constraints at later stages in the iterative process, I.e. longer connection lengths (or parasitics), are not as critical. This is because it is easier to make adjustments for longer wires so as to meet constraints. Longer wire lengths give the physical implementation tools greater flexibility to optimize placement and routing (allowing longer wire lengths). The resulting netlist and connection budgets (lengths and parasitics) form the basis of doing physical layout in a manner that meets or matches these constraints.

The method also describes means by which the parasitic budgets are used and maintained in the layout process. Specifically, the parasitic budget is used to control partitioning, clustering, placement, and layout optimization by the placement and router tool. The required connection (or parasitics) of each net can drive a smart connection implementation system using the method. Once placement is completed, a final pass of library component (cell) adjustment and connection (wire) adjustment can be done in the traditional manner to adjust the final performance.

In more detail, the invention comprises the following steps of a process to determine the proper components and the required connection lengths (or parasitics). The result of the process is an improved netlist which can be used as input to the place and route process tool to implement the component placement subject to the derived constraints.

The process of the preferred embodiment of the invention is as follows.

Starting with a netlist or language description of the circuit, map all components to the target component library by mapping or synthesis.

Determine a set of parasitics steps, i.e., connection lengths, to be used in Static Timing Based optimization in order to meet specified constraints. Connection length steps are chosen to be from zero to some other minimum length. Steps can be chosen based on cell size, row size, FPGA slice size, or based on input capacitance values. Steps are ordered from the smallest to the largest. Each fanout will have its own particular characteristic step, forming a consistent set of values.

Iteratively evaluate each path in the circuit at each step or iteration of assumed parasitic capacitance loading for every wire in the path. Next, apply the constraints to the mapped design (or modified design after each itteration) using timing analysis along with that step's connection lengths (or parasitics). Next, evaluate the circuit at the particular connection length (or parasitic) level. Perform gate sizing, or select another functional module which is equivalent and has higher output drive current capability, or do re-buffering, or re-synthesis as needed to meet constraints.

After each step, look at the cells and connections which are failing or near the limit of the constraint and optimize their components and/or shorten the connection lengths of the wires in the path. The fixing of the connection length can be adjusted as is needed to meet constraints or provide adequate desired margin. Shortening a connection length can be done in other than step size increments in some embodiments to meet timing and/or power constraints. After suitable adjustments in components and connection lengths are found which meet timing and/or power constraints, these components (cell) and connections (wires) will be fixed during subsequent iterations and can no longer be changed. Any paths which satisfy the constraint by more than a desired margin are passed onto the next iteration in a non-fixed state, and are run at the next highest level of connection length (or parasitic).

At each step of the connection length iteration some cells and connections will be “hardened” (cell selection fixed and net or wire length fixed at a length which meets timing and power constraints). When the circuit fails to meet constraints at the lowest level of parasitics, it is considered un-implementable. Iterations can stop when all connection levels have been evaluated, or the entire set of components and connection lengths (or parasitics) have become fixed.

Upon completion of the netlist hardening, the result is a modified mapped design component and connection netlist. We also have connection lengths (and parasitic) requirements for all nets, which is called the parasitic budget. This new data represents an improvement that can be physically implemented by back end tools such as the place and route tool.

The process may be run separately or in conjunction with the physical backend. Tools downstream may consume the new mapped design netlist and it's connection length data (parasitic budgets) for each net defined by the logical netlist.

During the hardening process, switching activity of a circuit can be incorporated in the iterative optimization process to harden connections with high switching activity at lower connections lengths. This can significantly reduce power without sacrifice in performance or layout.

Following the improved mapped design after parasitic budgeting and improvement are a set of partitioning and placement techniques used in layout implementation.

The first step in placement and physical implementation is, in some alternative embodiments, to read a set of pre-placements for cells or an existing placement (incremental design) if pre-placement is to be used. Pre-placement can be used to define user desired locations for I/O cells, Memories, IP-Blocks, etc. When pre-placement is used, the first step of clustering is applied based on location of pre-placed cells and their pins.

Connections that are short and connect to pre-placed components are used to seed the placement and partitioning process. Cells with short connection to pre-placed cells are pulled near the pins they connect to by the placement and routing process based upon weights assigned to various nets based upon the connection length (parasitic budget) requirements. Each level of logic around the pre-placed components can be evaluated as to the need to be close (or conversely far away) from the pre-placed macro. Performing this optimization can speed up circuit performance, decrease power consumption, speed the placement and partitioning process and otherwise improve results.

Without pre-placement or after pre-placement clustering, connection length information is used in guiding placement and partitioning clustering. Clustering of short connections can improve run time and results. Comparison or required connection length (or parasitic budgets) against expected fanout connection length distributions is used to drive clustering and global organization.

Connection lengths are used to provide information to the partitioning and placement engines of downstream tools as to which nets not to cut at various levels of partitioning. This information can skew the placement problem to give nets which must be short (since they are presumably on the more critical paths) preference to be at the short end of the wire-length placement distribution. The resulting method re-orders the fanout wire-length distribution to put critical nets be at the short end of the distribution of parasitic budgets.

Constraint tracking can be used to keep track of how well physical placement and implementation is doing against the required budgets and dramatically improve circuit performance of existing timing improvement and placement techniques.

Therefore, an object of the invention is to determine the connection lengths (or parastics) of wires in a circuit which will meet timing constraints giving priority to critical path cells and nets. The innovation is to evaluate the circuit under different connection lengths (or parasitics) starting from zero all the way to a maximum circuit size using dynamic or static steps on connection length (or parasitics). Each step in the evaluation may cause some critical paths to fail, and in turn solidify (fix) those library components and their connection lengths (or parasitics). The result is a optimized netlist of components and set of connection length (or parasitic) constraints, we call the parasitic budget, that provides a guide for the physical implementation tools which use this information to produce a faster, smaller, lower power, layout of the integrated circuit.

In accordance with a preferred embodiment of the invention, there is disclosed a methods for evaluating the circuit, generating the appropriate connection (or parasitic steps), hardening or fixing some wire lengths and component choices at each step of evaluation, generation of final connection length (or parasitics) budget, and finally the methods of using the information to produce a placement and layout using the netlist and budgets.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1. is a description of the high level flow through the optimization system

FIG. 2. describes the core of the method used in determination of the parasitic budget.

FIG. 2a. describes the overall flow, inputs and outputs. FIG. 2b. describes the flow at each iteration of the method. FIG. 2c. describes an alternative embodiment for the flow and actions taken on each iteration of the method. FIG. 2d is a flow chart of an alternative embodiment utilizing a power optimization process.

FIG. 3. is a description of the basic topology of a critical path element with a component (library cell) driver cell with a driving output, connection (wire or parasitic) connecting one or more next stage components and the next stage components with their input parasitics.

FIG. 4. is a description of a critical path starting at a primary input or register (flip-flop or latch) a number of critical path elements, ending in a primary output or register (flip-flop or latch)

FIG. 5. is a graph of a critical path element delay as a function of increasing number of next stage loads as well as increasing connection length (or parasitic).

FIG. 6. is a description of delay of a NAND2 component (library cell) in a typical semiconductor library as a function of load. FIG. 6a) shows a typical connection pattern with identified parasitics. FIG. 6b) Is a graph of delays that result when the gate is not loaded, when Cwire=0.0, when Cwire=Cin, when Cwire=2*Cin and so on.

FIG. 7. is a symbolic table of connection lengths that match a typical next stage input parasitic for various examples of today's semiconductor processes.

FIG. 8. is an example distribution of connection lengths generated from a sample circuit organized by connection fanout. This illustration shows the distribution of connection lengths that occur in each fanout. Bars are drawn to indicate the approximate point where Cwire=Cin for each net distribution.

FIG. 9. is a symbolic representation of a three critical paths that can meet their timing, power, etc. goals based upon different connection lengths. The path which has more stages of logic must have shorter connection length than the path with two stages of logic

FIG. 10. is a symbolic representation of cell row layout that is common to today's semiconductor circuits showing connections which are very short (neighbor cell), a connection between two row, and connections between many rows.

FIG. 11. is a symbolic representation showing lookup table connections inside a field programable gate array showing carry chain connections, fast local connections and slower global connections.

FIG. 12. shows a symbolic translation of connection lengths (or parasitics) to weights for incorporation into the placement or partitioning engine. The shorter the connection length (or parasitic) the higher the priority is given to the connection.

FIG. 13. shows the clustering of components around a partition boundary based on the required connection length (or parastic) keeping shorter connections closer to the partition boundary.

FIG. 14. shows clustering of components (cells), to be placed, around pre-placed memories, I/O, hard IP, etc. based on initial requirements of connection length. Keeping connections that must be shorter closer to the pins of the pre-placed components.

### DETAILED DESCRIPTION OF THE PREFERRED EMBODIMENT

Detailed descriptions of the preferred embodiment is provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Definitions

For purposes of the claims, the term cells will be used to refer to the functional modules from the target component library which are used to implement the Boolean logic of a path.

A path is a unit of circuitry for which a power and/or timing constraint is defined, and each path is comprised of cells and/or conductive paths between cells referred to herein as wires or nets or connections.

The terms parasitic budget loading or parasitic capacitance loading or length when used in reference to a conductive path all mean the amount of parasitic capacitance a conductive path will have in any particular technology and process of integrated circuit fabrication. A parasitic budget for a conductive path means the maximum amount of parasitic capacitance, I.e., length, the conductive path can have in an integrated circuit layout for the path of which the wire is a part and still meet the timing and power constraints required of the path.

The term parasitic capacitance loading assumption as used in the claims means the amount of parasitic capacitance assigned to each wire in a path during an iteration and which is used in static timing analysis of said path to determine if said path meets timing and/or power constraints set for the design.

Static Timing Analysis, as used in the process of the invention, is a class of timing simulators used for Integrated circuit analysis that employs state analysis methods on logic, for computing the delay times for a path. A path may be between any combination of primary inputs and outputs and registers in the circuit. Static timing analysis does not require the creation of a set of test (or stimulus) vectors, but only clock definitions and definitions of signal behavior (constraints) that must be met. Longest delays between primary inputs and outputs and registers are called critical paths and are composed of components (cells) and connections (nets or wires).

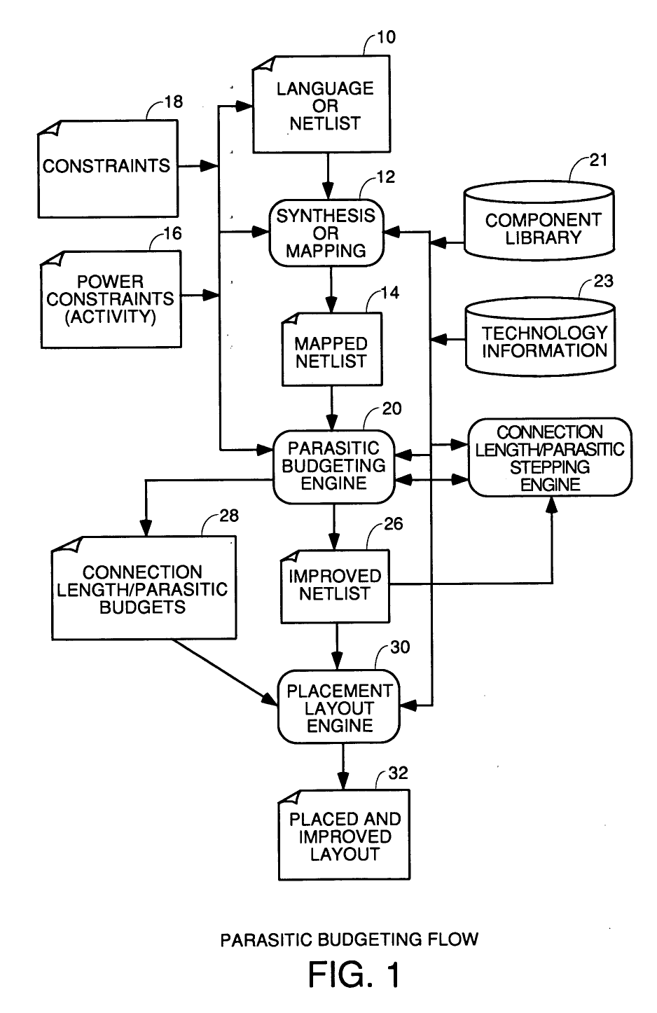

The flow described in FIG. 1. starts with a source netlist 10 or logical representation of the circuit. Any elements that are not mapped in the source to the target component library (cells) are mapped by synthesis or mapping techniques represented by block 12. Inputs to the synthesis or mapping step regarding the cell components or modules in the design come from component library 21, and information regarding the technology the components are to be integrated in comes from technology information data store 23. The resulting “mapped” netlist 14 contains a network of components and connections describing the circuit to be implemented.

Constraints 16 and 18 are provided to define the desired limits of timing and power behavior and to explain behavior of components and connections. Timing constraints 18 define clocks, signal arrival times, signal required times, timing exceptions, and in some cases parasitics that must be met. Power constraints 16 define switching activity of the circuit as well as target numbers for dynamic and leakage power.

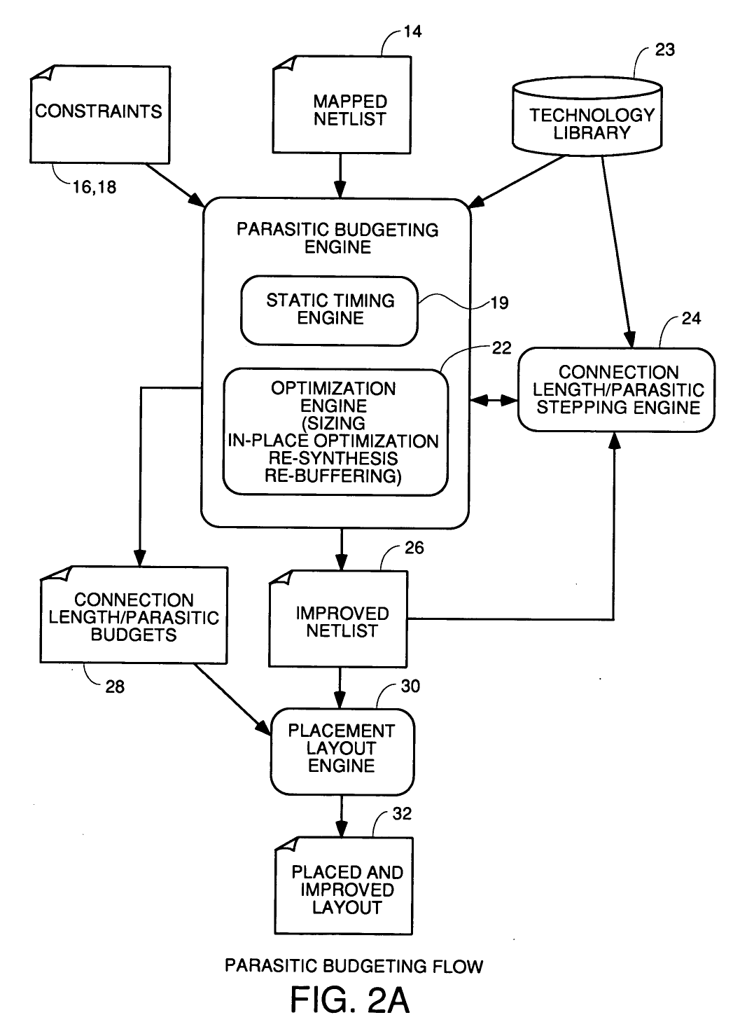

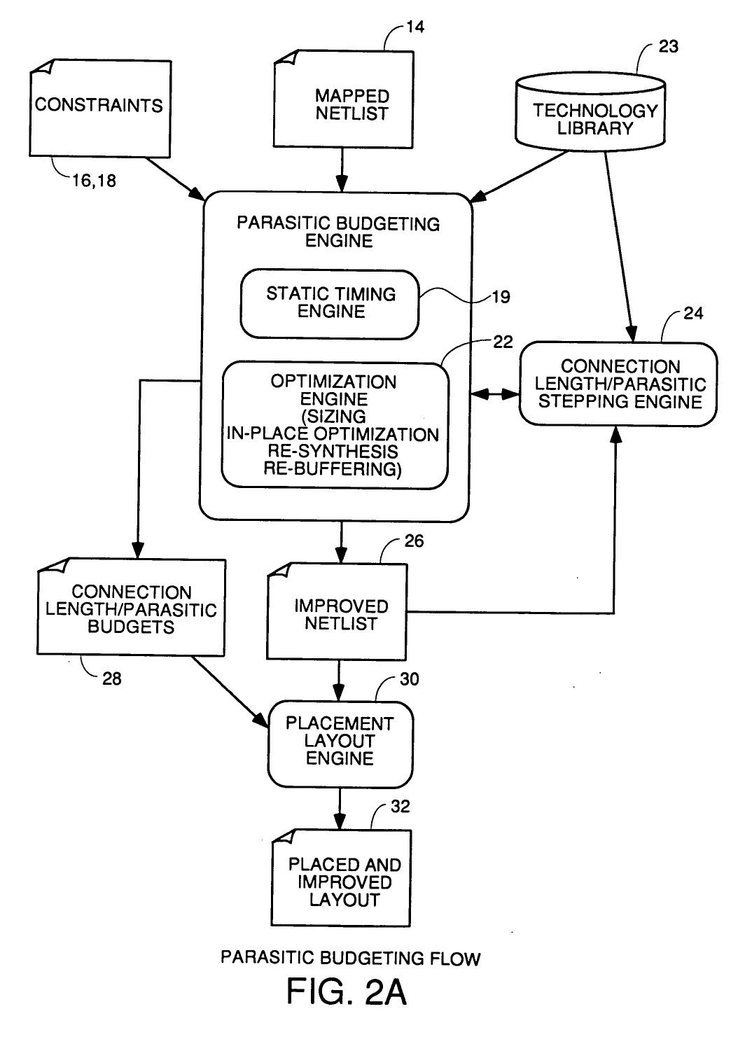

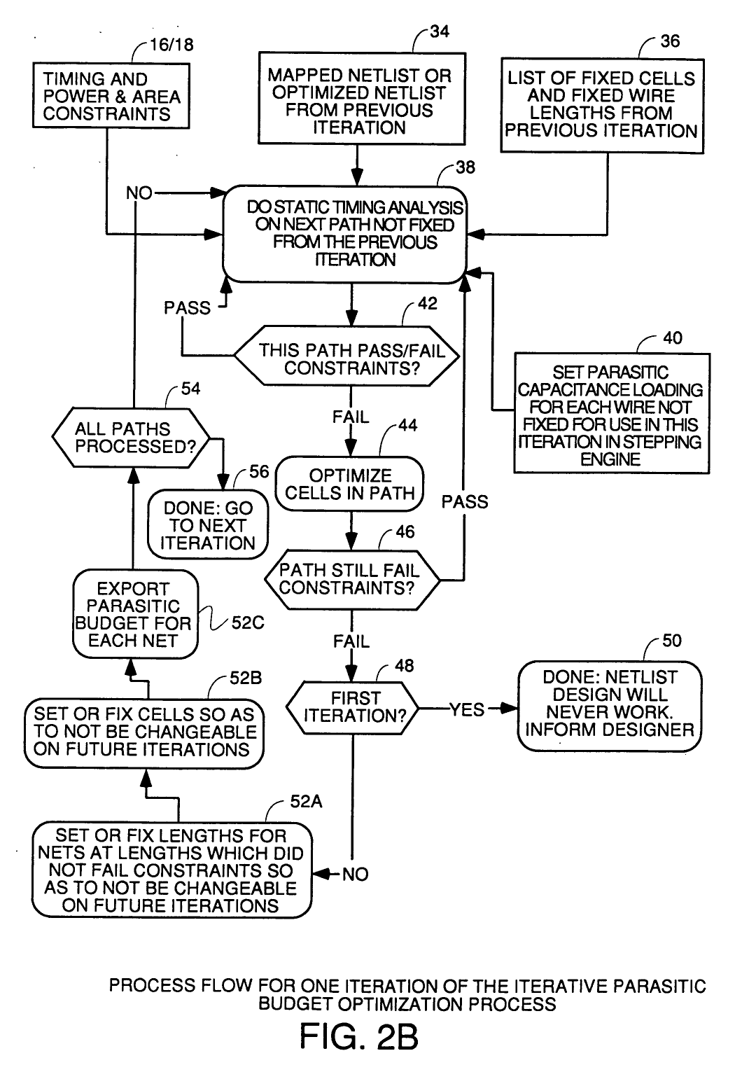

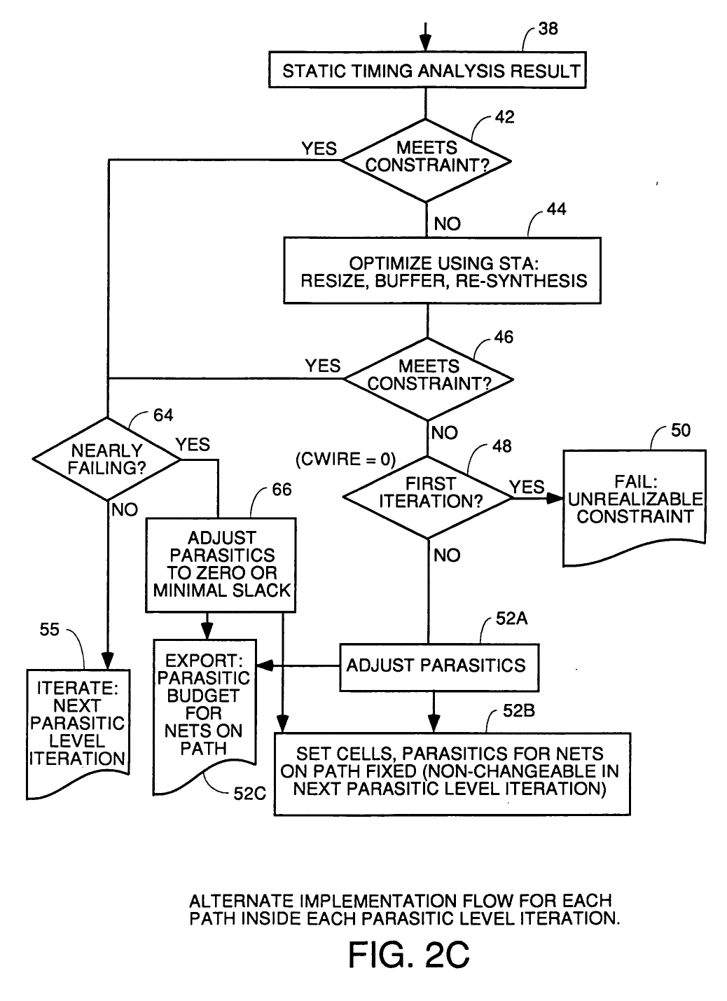

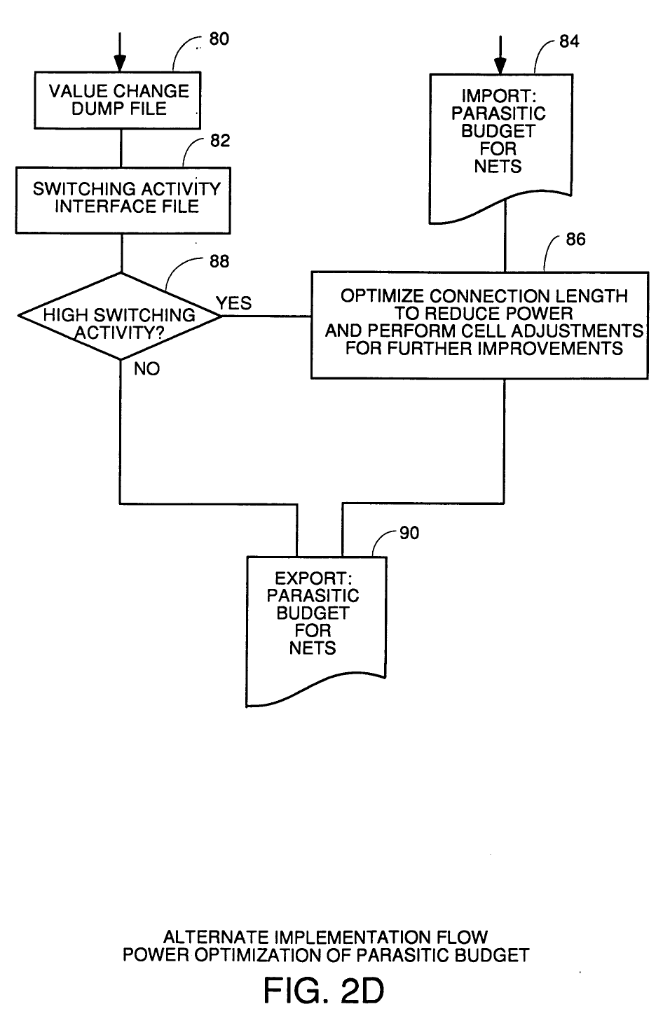

A key part of the method is the iterative parasitic budgeting process implemented by parasitic budgeting engine 20. This iterative parasitic budgeting process uses a Static Timing engine 19 in FIG. 2a to do static timing analysis to evaluate the circuit of each path to see how close the circuit defined by the mapped netlist 14 comes to meeting the desired constraints. Inputs to the engine 20 are the netlist of the circuit, constraints, and the current level of parasitics. At the first iteration, the original netlist from the previous stage is used, and connection lengths (or parasitics) are set to zero (or some other minimum value which can be arbitrarily selected but which is usually selected to be Cᵢₙ or the value of parasitic capacitance in a net from one row of the design to an adjacent row). That is, the parasitic capacitive loading of every wire or net in the mapped netlist are set to the minimum parasitic capacitive loading value (which defines the step size between iterations) for the first iteration.

FIG. 2, comprised of FIGS. 2a, 2b, 2c and 2d shows the inner workings of the iterative parasitic budgeting or optimization process. The parasitic capacitance value selected for the current iteration (the minimum level for the first iteration) is assigned to each of the non-fixed nets (all nets or wires are non-fixed on the first iteration). After this is done, each path in the circuit (a path is all the nets and components in the circuit between the nodes specified in a timing and/or power constraint) is evaluated using the static timing engine process 19 in FIG. 2a to see if the path meets power and timing constraints, and how closely. If a path composed of components (cells) and connections (wires or nets) fails, the components in the path are optimized in step 22 of FIG. 2a in an attempt to meet or exceed constraints. This means that different components or functional modules which perform the same function are tried for the failed path or the module which drives it. The new components usually have bigger output drive current capability for the component driving the failed path or components in the failed path are selected which have the same functionality but which have lower input parasitic capacitance Cᵢₙ, are chosen for the path. Other things that can be tried is the re-buffering or re-synthesizing the logic of the path altogether to get the same overall result.

After optimization, static timing evaluation on the path is performed again to see if the path now meets constraints. At the end of the optimization phase at each parasitic capacitive loading, results of the static timing analysis after the optimization step are used to fix (also referred to as “hardening” elsewhere herein) critical components and connections for the next phase of optimization so that they cannot be altered during subsequent iterations. What this means is that paths that fail have their maximum length or parasitic budget (parasitic capacitive loading) set at a value which does not fail which is usually the parasitic budget or length used in the previous iteration for the path which resulted in the failed path not failing. Reducing the length of the net to get the path to not fail constraints is not limited to stepwise reduction using the minimum step size, and the length can be shortened in any desired increment until the path passes. Also the components used on the path by the optimization process are fixed or hardened so that they cannot be altered in future optimization steps. Resulting fixed connection lengths are saved for the parasitic budget which will be output with the final netlist. Paths that pass after the optimization step are not fixed and move on to the next iteration where the next higher level of parasitic budget or parasitic capacitive loading (net length) will be set for all wires in paths not fixed by the previous step.

In FIG. 2a, the block “Connection Length/Parasitic Stepping Engine” 24 is a key component of the optimization process. Based on library data from technology library 23, process 24 is responsible for determining the connection lengths (parasitics) that are to be used at each step of the iterative parasitic budgeting process. While the exact value of the parasitic budget steps (minimum step size which translates to a minimum wire length with a minimum parasitic capactive loading value) is not critical there are key species within the genus. In one species, the minimum step size is determined by the value (or an average value) of the input capacitance of the components in the library. In another species, the minumum step size is determined based on wire characteristics. In another species, the minimum step size is determined based on the minimum length of a wire between adjacent rows or some other minimum distance that commonly occurs in a cell layout. In another species, minimum step size is defined by classes defined in Field Programmable Gate Arrays. In another species, any method that relates the timing and power characteristics to the behavior of the netlist may be used to set minimum step size.

Steps are taken in a systematic manner, normally in increasing parasitic budget (capacitive loading or length) order, but the length increase or incrementation in the capacitive loading between steps in the iteration is not necessarily linear. For example, larger steps can be taken for the iterations dealing with longer nets when a large number of nets are fixed.

The actual process the computer implements to do one iteration in the iterative optimization of parasitic budgets for the wires in each path of the design is shown in FIG. 2b. The inputs to the iteration are: the chip area and timing and power constraints 16/18; the mapped netlist from the previous iteration, with certain paths optimized if any optimization of a path was done in the previous iteration; and, a list 36 of the cells and wire connection lengths (parasitic budgets) of wires and cells that have been fixed in the previous iteration. A static timing analysis is done on the first path not fixed from the previous iteration in step 38. This is done by setting the cells in the path at whatever is specified in the netlist or optimized netlist input 34 and by setting the parasitic capacitive loading of each wire in the path at a level established by the stepping engine for this iteration, as symbolized by step 40. Each path not already fixed is checked in this way by the static timing analysis. Test 42 determines if the path currently being optimized has passed the power and timing constraints. If the path passed the constraints, processing flows back to step 38 to pick the next non fixed path. If the path failed any constraint, it is passed to the optimize paths process 44. There, the cells in the path are optimized in an attempt to meet constraints. For example, a cell which serves as an input driver to a path may be chosen which has a higher drive current capability so as to meet a timing constraint which is not met by the currently existing cell in the path. Likewise, a buffer may be added somewhere in the path to refresh a decaying signal waveform using the output current drive capability of the buffer. Likewise, one timing result may occur if a cell in a path is a four input NAND gate whereas a different, better timing result may occur if the four input NAND is deleted and two NANDs, each of which has two inputs are substituted (re-synthesis). Chip area constraints come into play in this process. For example, substituting a cell with a higher output drive capability or substituting two 2-input NANDs for one 4-input NAND may solve the timing problem, but because the cell (or re-synthesized circuit) is larger, it causes failure of a chip area constraint. All these things are considered in the cell optimization process of step 44. Step 46 tests whether the path with the optimized cells still fails the constraints. If not, processing flows back to step 38 to pick the next path. If the path still fails, test 48 is performed to determine if this is the first iteration. If it is, the conclusion is drawn that the netlist, as currently designed, will not work and must be redesigned. Step 50 is performed to inform the designer. If this is not the first iteration, steps 52a, 52b and 52c are performed. Step 52a fixes or “hardens” the lengths of nets which have failed timing or power constraints at lengths which do not fail (usually the length in the next previous step which passed). Step 52b sets or hardens the cells selection for the path at the original cells or the new cell structure established by step 44. Step 52c exports the parasitic budget (maximum length) for each net which has been hardened. After steps 52a through 52c are performed, processing flows to test 54 to determine if all the non fixed paths to be optimized have been processed by this iteration. If so, step 56 is performed to go to the next iteration as this iteration is done. If not, processing flows back to step 38 where the next non fixed path to be evaluated in selected and the static timing analysis is done on it.

Determination of the parasitic capacitive loading of various connection lengths of wires, including the minimum length that establishes the iteration step size, is based on component layout topology as well as the technology used to fabricate the chip. Determination of input capacitance of library components (cells) is based upon the cell layout and technology. For example, the parasitic capacitive loading value of the minimum step size may set set equal to the parasitic capacitive loading of a wire whose length is determined as a multiple of the standard cell (or CLB for FPGA) row spacing or the length of a wire that can connect nodes in adjacent rows (cross one row), or it can be set at the loading of a wire that crosses 2 rows, 3 rows . . . . or N rows.

Also parasitic levels for the minimum step size used can be and often are based on the parasitic input capacitance of components (cells) in the design. Example: Parasitics can be stepped from C_{wire}=0 to a fraction of Cᵢₙ, to Cᵢₙ to several times Cᵢₙ.

The stepping engine 24 determines the steps and the number of steps the optimization is to take based on technology, component library (cells) and connection characteristics (wires). Since connections have different number of fanouts (next stage connections), parasitics are not uniform for all nets but are adjusted for fanout and connection class (clock, reset, etc). Optimization stepping can be stopped when all paths are fixed, optimization fails, or when the maximum connection length for the chip (determined by the stepping engine) is exceeded.

The output of the parasitic budgeting engine is an improved netlist 26 with a connection length/parasitic budget 28 for each wire defined by the netlist. The improved netlist 26 and the connection length/parasitic budget for each wire in the design are input to the placement layout engine 30 which places the cells in the design on an integrated circuit layout and routes the necessary connections between the nodes of the cells in the design. The result is a chip layout 32 where the circuit components are laid out on an integrated circuit with wire lengths between nodes which have been set according to the connection length/parasitic budget weighting so as to meet power and timing contraints 16/18.

FIG. 2c. is a flowchart for an alternate implementation of a method according to the teachings of the invention that not only generates parasitic budgets and fixes cells for failing paths, but also adjusts and generates these for early failing paths. Steps having like reference numbers as the embodiment represented by FIG. 2b do the same processing as previously described in connection with the discussion of FIG. 2b. The embodiment represented by FIG. 2c allows for faster convergence in cases where there are large variations in capacitance. The method in FIG. 2b. fixes cells and connections only on failing paths. The alternative embodiment shown in FIG. 2c. looks at the margin by which constraints are met in step 64. Cells and connections on paths that are not nearly failing are determined in test 64 and passed on to the next parasitic level iteration in step 55. If a path fails constraints in test 46, the processing of test 48 and steps 50, 52a, 52b and 52c are performed to either warn the designer that the design will never meet constraints or have parasitics adjusted, then yield a parasitic budget and fixed cells as previously described . If test 64 determines that a path is nearly failing, step 66 is performed to adjust the parasitics to zero or minimal slack. What this means is that when a path is subjected to static timing analysis with its nets set as whatever the length for the current iteration, the “slack” between the performance of the path timing-wise and the timing constraint will be negative if the path fails the constraint and will be positive if the path passes the timing constraint. Step 66 is reached with the slack is positive and represents the process of changing the net length, usually iteratively, until the slack is zero or some minimum value. For example, suppose a path has a timing constraint that a signal will propagate across the path and cause a switching even in nor more than 10 nanoseconds. Suppose with the current net lengths in the path, the static timing analysis shows that the path will cause the switching event to occur in 9 nanoseconds. This is 1 nanosecond positive slack. Increasing the length of the nets causes the path to pass by less margin. Step 66 represents the process of increasing the length, usually incrementally until the slack is zero or some minimal positive value. Then steps 52b and 52c are performed. This change in the process causes convergence on a fully hardened set of cells and parasitic budgets for nets to happen faster.

During and after the iterative process of computation of the parasitic budget (optimizing component selection and establishing a maximum net length which passes constraints), further refinement for meeting power constraints can be accomplished. A process to do this is shown in FIG. 2d. Using an input representing the amount of switching activity a path will see during operation of the circuit for each connection or group of connections, optimization to minimize both switching and leakage power can be performed in the embodiment represented by FIG. 2d. Switching activity causes power consumption in integrated circuits by leakage as the parasitic capacitances are charged and discharged as the voltage on a path goes back and forth between logic 1 and logic 0. Switching activity level is computed by statistical methods or by generating a Value Change Dump (VCD) file (shown at 80 in FIG. 2d) from simulation. This information is used to compute the number and kind of transitions a connection on the netlist will experience during operation. This data can be further compressed into a Switching Activity Interface File (shown at 82—SAIF) for use as an input to the interative net length and cell selection optimization process according to the teachings of the invention. Once a connection length is fixed and the cells in the path are fixed in the parasitic budgeting process, the nets in the path may contain some slack in terms of cell characteristics or shorter connection lengths that can be implemented and still meet constraints. Using the power constraints and the SAIF or switching activity information, parasitic budgets can be further refined to give shorter connection lengths for nets thereby reducing the parasitic capacitance load of each net shortened in this process. In FIG. 2d, this process is as follows. In step 84, the parasitic budget for nets which have been hardened is imported. Then step 86 is peformed to determine for each net using the data input in steps 80 and 82 and test 88 whether the net has high switching activity. If it does, step 86 is performed to optimize the connection length to reduce power consumption by losses to the parasitic capacitors. Step 86 may also optimize cell selection or re-synthesize the logic of the path so as to maintain the same functionality but to lessen power consumption. If test 88 determines that a net does not have high switching activity, the power optimization step of block 86 is skipped. If a path does not have high switching activity or after its power consumption has been optimized in step 86, the parasitic budgets are output for the net. The steps of FIG. 2d can be incorporated as alternative embodiments into the process of either FIGS. 2b or 2c after a path has been initially hardened so as to do further optimization for power consumption. After the power consumption optimization process, the process of FIG. 2d finally hardens the net lengths and cell selections at the selections which reduce power consumption but still meet all the constraints and exports the final hardened values in step 90.

The process of FIG. 2d is done (in the power consumption minimization embodiments) at least for nets which switch at high frequencies and minimizes the dynamic switching power which is consumed as the parasitic capacitance of the net is charged and discharged. Cells can also be optimized to account for voltage thresholds in order to minimize leakage power. The parasitic budget of large fanout nets contributes the majority of wire length in a design. These nets often are not critical but do have significant load. By incorporating switching activity information in the optimization process, power consumption can be dramatically reduced in high activity nets.

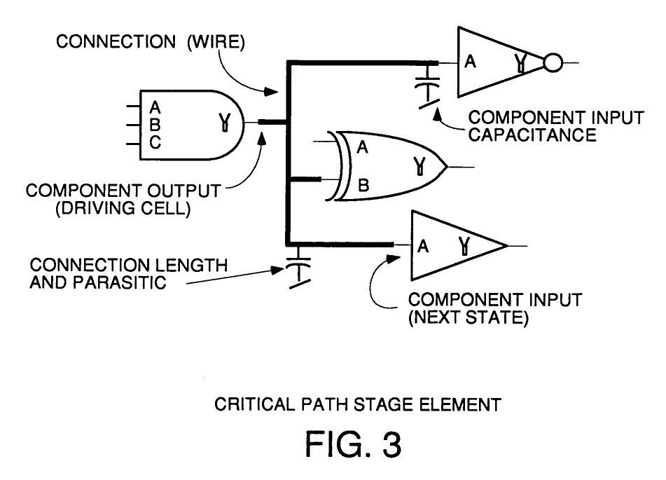

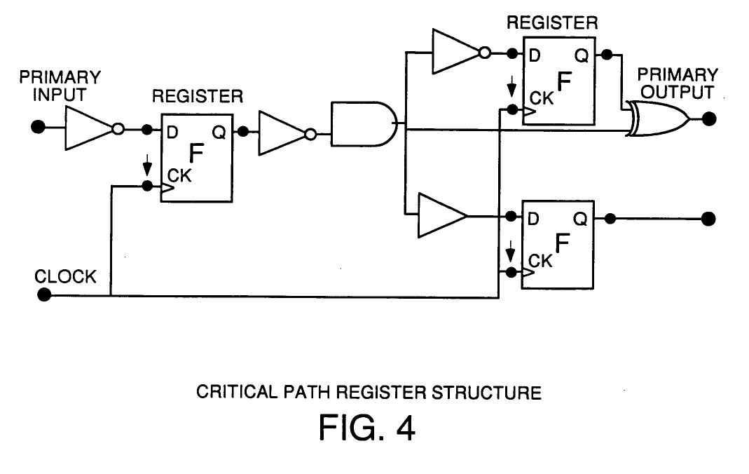

FIG. 3. describes the basic topology of the combinational network of elements in between registers that is in the netlist and must be implemented in layout meeting the final constraints. FIG. 4. defines a network of combinational elements that terminate in registers of primary inputs/outputs that form the basic structure of static timing problem to be solved. Constraints applied to the network define the limits of operation that must be met in order for the circuit to be correctly implemented.

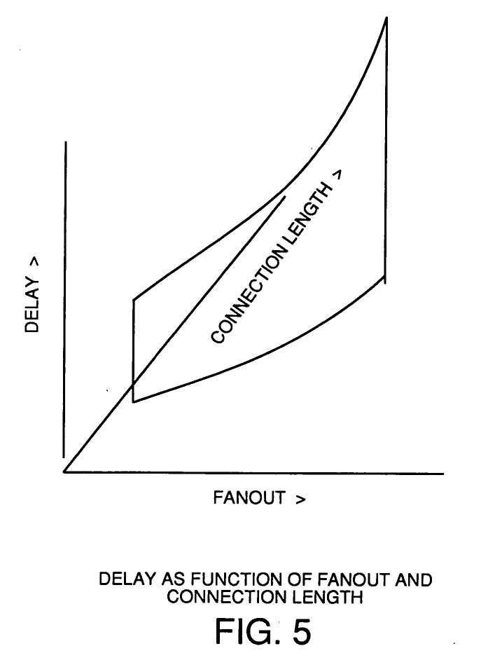

Semiconductor processes dictate component (cell) and connection (wire) behavior. In other words, different processes to make the same structure cause the same cells and wire lengths to have different parasitic input capacitance for cells and different parasitic capacitance loading for the same length wire. Also, the fanout of a path alters its performance by adding parasitic input capacitances of more cells together in parallel along with summing parasitic capacitance of multiple wires to multiple cell inputs. FIG. 5. shows a graph of delay of a cell in a typical modern process as a function of both fanout (number of next stage elements) and connection (wire) length. The figure shows an element operating a 5-6 times the speed at low fanout and light load as compared to even a moderate fanout and load. Each class of gates has its own characteristic drive and timing behavior. Many larger cells cannot operate properly under heavy fanout or connection length loads.

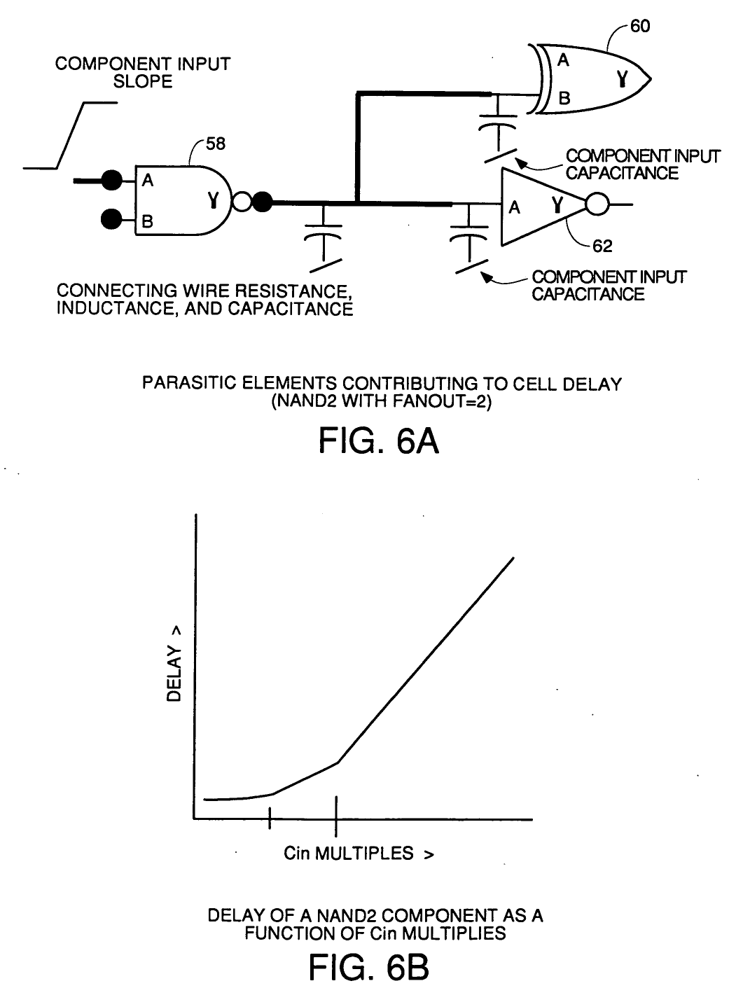

FIG. 6a shows a typical component connection stage along with the various components that lead to parasitics. The cell has input slope (rate of rise of voltage at the cell input over time) that is defined by the drive current capability of the previous stage of logic as the drive current charges up the parasitic input capacitance of the cell. The component (cell) has a particular model for timing and power defined by the process, and library designer. The cell will have some delay when there are no loads because of its own output capacitance. The cell connected into a next stage will have a load that is C_{wire} plus summation of Cᵢₙ for all inputs of cells connected to the fanout wires of the net. The Cᵢₙ parameter is the capacitance of the input of the next stage of logic. If there are N-fanouts then there will be N*Cᵢₙ capacitors for each gate, and the parasitic input capacitance Cᵢₙ of all the N cells connected to the N fanout nets will be added together in parallel to slow down the propagation of a voltage change to the inputs of the N cells.

FIG. 6b shows sample numbers for typical semiconductor process of the gate delay with no output connections, connection to the next stage made by abutment (zero length connectors where C_{wire}=0.0), short adjacent row connection (C wire=0.5*Cᵢₙ), Connection of length equal to Cᵢₙ(C_{wire}=Cᵢₙ), and successively longer and longer connections. You can see that delay grows exponentially with load in the example. The example graph shows the delay for a path comprised of three cells in FIG. 6A NAND2 at 58 at, NOR4 shown at 60, and an inverter 62. Different cells have different exponential behavior with load.

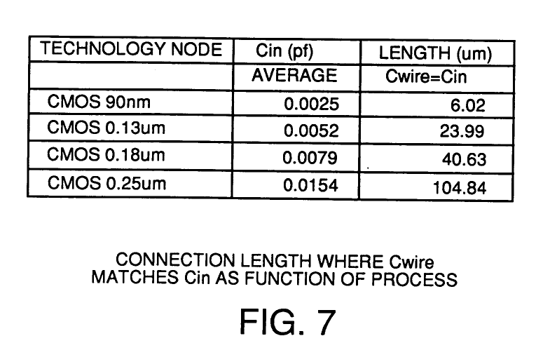

FIG. 7. shows the trend towards C_{wire}=Cᵢₙ occurring at ever shorter wire lengths with each successive semiconductor technology (smaller line widths meaning smaller transistors, smaller cell sizes and smaller input capacitance) going from 0.25 um to 90 nm. The resulting shortening of this point represents the fact that for gates to be fast, they have to closely connected in the layout. In other words, small gates with small input capacitance are fast, but if they are connected by long nets, the parasitic capacitance of the net dominates the performance figure and drags it down. Drive (output impedance) of components has been getting larger with each new generation of technology, increasing delay of gates with many series transistors due to lower voltages in new processes.

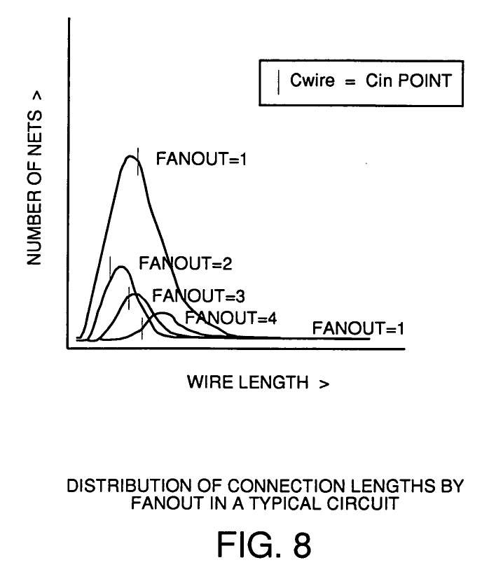

The iterative parasitic budget optimization process results in various “buckets” each “containing” a plurality of paths with different fanouts (called connection classes), each of the nets or wires in the path having a parasitic budget or length with the collection of all nets in the paths in the bucket defining a sort of bell shaped curve like those shown in FIG. 8. FIG. 8 shows a typical distribution of net length buckets for a typical circuit. Each connection class (organized by fanout) will have some distribution of long and short nets after placement. Each fanout will have connection lengths whose parasitics are less than Cᵢₙ, equal to Cᵢₙ, or larger than Cᵢₙ. The larger the C_{wire} the more sensitive the delay is to wire placement.

Because connections at a particular fanout have differences in length, this fact can be exploited to reduce both timing and power. Giving preference for shorter lengths (or parasitics) to critical path nets can improve performance. Likewise since component length is a significant portion of capacitance, giving preference for shorter connection length (or parasitics) to nets which have high switching activity can reduce power consumption in a circuit by taking high _cv**2*frequency nets and reducing their capacitance.

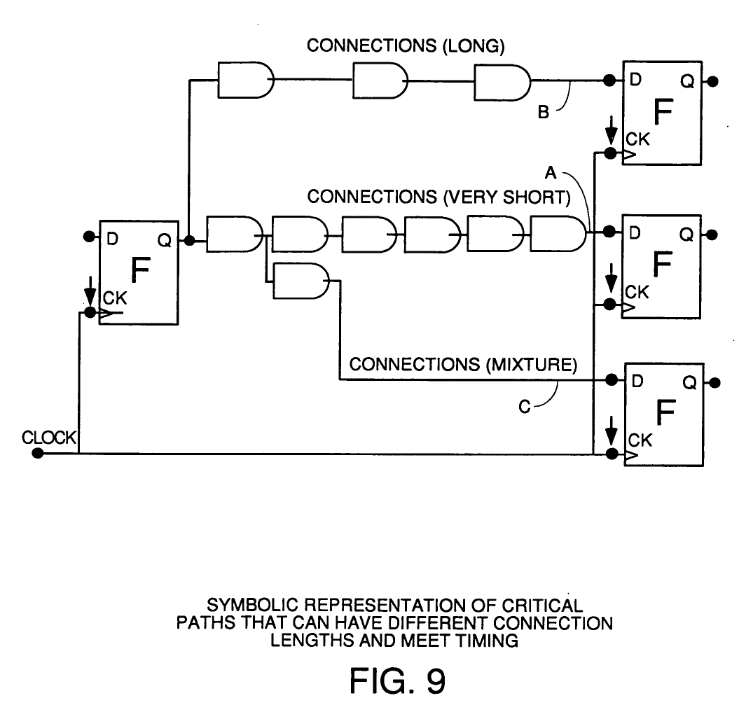

FIG. 9. defines a small network whose constraint needs to be satisfied. In the case of the figure Path A has 5 combinational logic stages between registers while Path B has 3 combinational logic stages, and finally Path C has only 2 combinational logic stages. This figure is used as an illustration of the kinds of problems, and later the method proposed, in solving these problems.

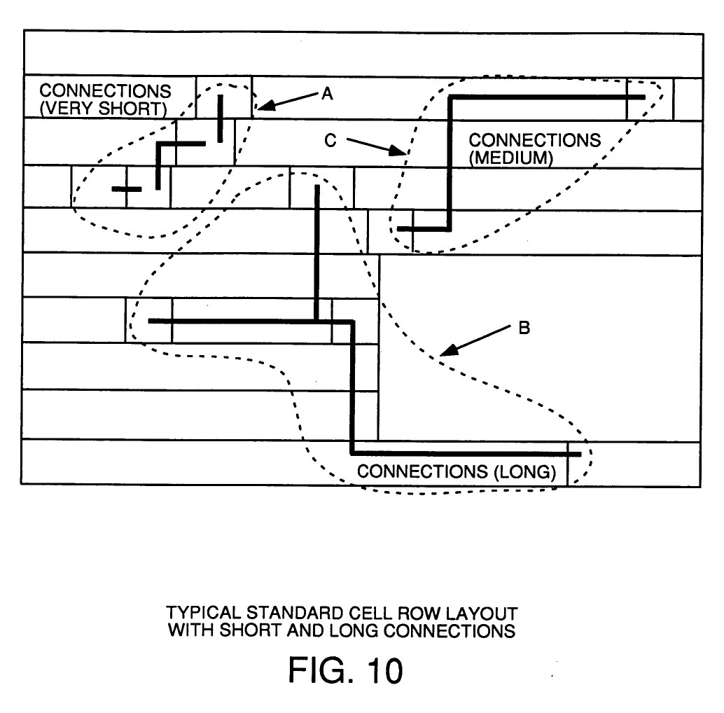

FIG. 10. shows a symbolic representation of an semiconductor chip placement and component sizing that results in the layout implementation of the circuit in FIG. 9. You can see the Path A being placed in a tight formation with minimum connection length. In contrast, in Path C constraints can be satisfied if its components are much further away from each other.

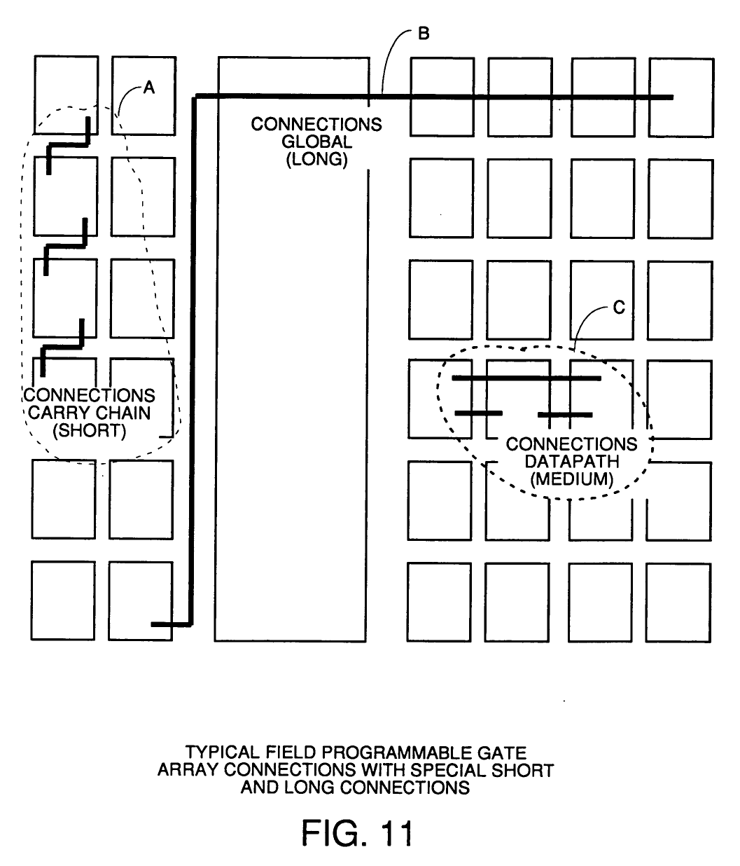

FIG. 11. shows a symbolic representation of a field programamble gate array implementing the layout of FIG. 9. Notice that Path A is placed on high speed carry chain connections inside the array between CLB elements while Path B is placed on slower global tracks in the FPGA.

The required connection lengths and connection classes developed during the iterative parasitic budgeting process is used to drive the placement process in implementing the layout of the circuit. The following discussion defines the usage of the component length (or parasitic) budget information in layout implementation.

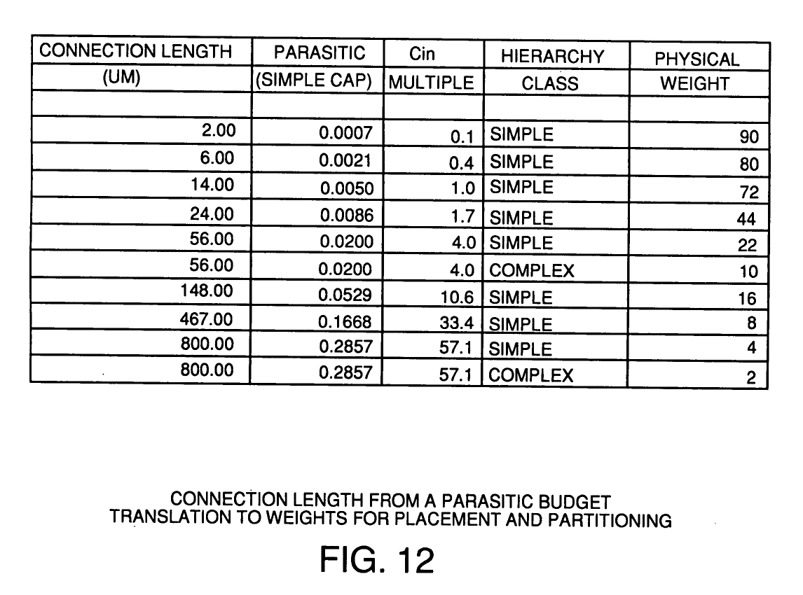

FIG. 12. shows a symbolic table where connection lengths (or parasitics) are translated to net weights for use by the place and route tool in partitioning. Shorter connections are given more weight. This skews the results of the prior art place and router tools and tends to prevent shorter connections from being cut across partition boundaries. In other words, the shorter the required connection (or lower the parasitic) the higher the priority that is given to the connection thereby improving the chances that the connection will not be cut along a major partition boundary.

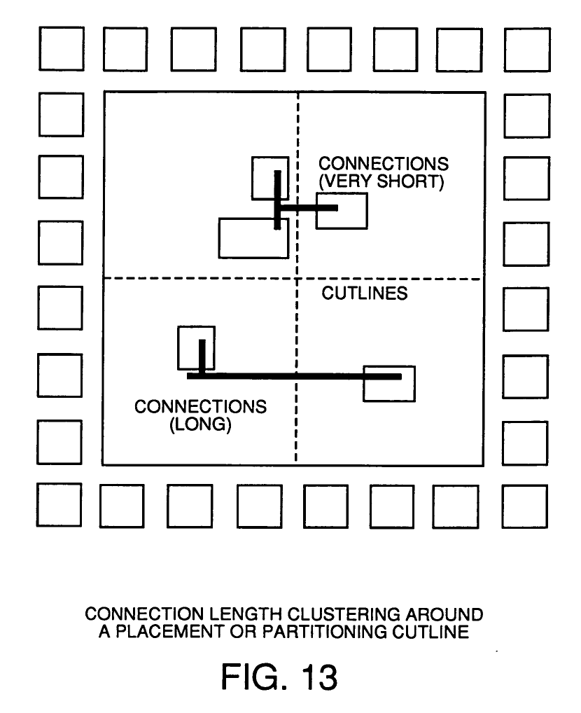

FIG. 13. shows how connection lengths are used to cluster cells around partition boundaries based on their required connection lengths (or parasitics). The placement area has been partitioned into 4 quadrants. Since some shorter connections have components on both sides of the partition boundary (I.e. in different quadrants), their cells are organized by the placement tool around the partition boundaries in order to allow nets that must cross the partition boundary to meet their length constraints.

Circuit layout process tools are often faced with the need to preplace some components (like memories, I/O, blocks, etc). Parasitic budget connection length optimization provides a means of improving and speeding placement in the case where there are pre-placed I/Os, memories, IP blocks, or other cells. Since the budget is made up of connection lengths, cells that are connected to preplaced cell pins by connection nets, can be seeded a specified distance from the position of the pre-placed cell pins. Short connection lengths between cells and preplaced cells will imply the non-preplaced cells must be placed by the place and route tool within a short radius of the pre-placed cell pins to which they are connected. Cells connected to these cells that are connected to preplaced cells define a larger radius based on the sum of the initial and secondary connections. Bounding the distance from pre-placed macros seeds partitioning, clustering, cell and block placement based on the connection lengths. This results in faster convergence on a final placement solution by the place and route tool and improved quality of placement results.

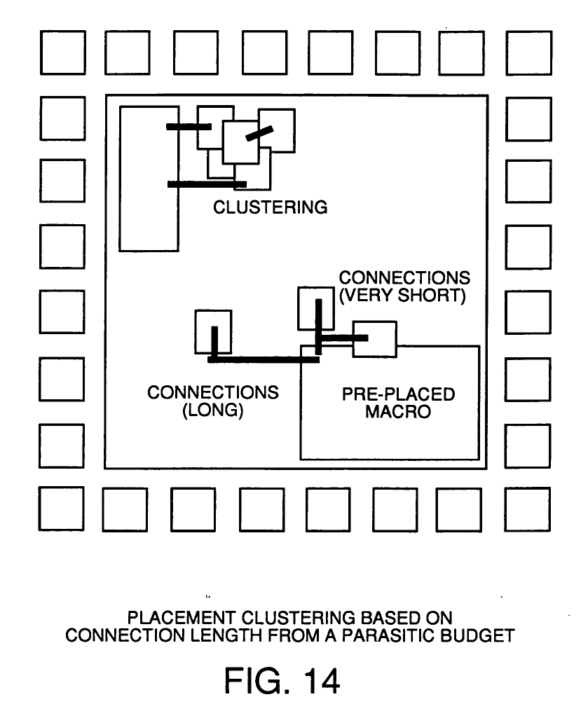

FIG. 14 shows a placement and routing result based upon the improved netlist created using the iterative parasitic budget optimization method and starting from pre-placed components. The placement and routing method whose result is shown in FIG. 14 comprises: 1) identifying pre-placed components; 2) then components to be placed are clustered by distance for the nets set by the parasitic budget optimization process so as to be near the pre-placed pins in order to seed the placement and partitioning solution. This exploitation of required connection (wire) length allows for more reliable placement and faster timing results.

Circuit layout process tools often perform Block Placement. This is placement of hierarchical blocks, memories, analog, etc whose size is large compared to the small atomic cells used for base logic functions. The parasitic budget provides a means of improving block placement by using defined connection length to provide connectivity between blocks, edges of blocks, pins on blocks, and using this information to better organize the block layout. Existing methods have no means of knowing ahead of time, in an automatic manner, which objects in block placement are required to be adjacent to each other to meet the various area, timing and power objectives. This improvement can radically improve speed, and improve the quality of block placement.

What is claimed is:

1. A method comprising optimizing the selection of functional cells and proposed maximum lengths of conductive paths in an integrated circuit so as to generate an improved netlist and a data file defining groups of conductive paths in said improved netlist, each group having a defined maximum length or maximum parasitic capacitance loading for conductive paths in said group such that if said integrated circuit is physically defined by a placement and router tool using said improved netlist and said defined maximum lengths or maximum parasitic capacitance loading for conductive paths is used by said placement and router tool, said integrated circuit will meet timing and power constraints established for said integrated circuit.

2. The method of claim 1, wherein said optimizing step is iterative and is comprised of a plurality of interations, and wherein prior to any iteration, the following steps are performed:
storing timing and power constraints for said integrated circuit;
storing a mapped netlist or optimized netlist defining the circuitry of said integrated circuit;
storing a list of fixed cells and conductive paths from a previous iteration, if any;
and wherein each iteration comprises the steps:
A) selecting a path defined in said netlist which does not have its cells and wire lengths fixed, and setting a parasitic capacitance loading assumption for all wires in said selected path with the level of said parasitic capacitance loading assumption being based upon an iteration number;
B) doing a static timing analysis on said path selected in step A) and determining if said path meets timing and/or power constraints established for said path;
C) if said path passes all timing and power constraints, returning to step A) and selecting another path defined by said netlist which does not have its cells fixed and its wires fixed in length, and repeating the steps of said iteration starting with step A) for said next selected path;
D) if said path evaluated in step B) fails any timing or power constraint, performing an optimization process on the cells in said path in an attempt to get said path to pass timing and power constraints;
E) if said path passes all timing and power constraints after optimization, returning to step A) and repeating the steps of said iteration starting with step A) for another path whose cells are not fixed and wires are not fixed in length;
F) if said path still fails any constraint after said optimization process of step D), determining if the current iteration is the first iteration;
G) if the current iteration is the first iteration, generating a message that the current design encoded in said netlist will not be able to meet constraints when laid out by a placement and routing process;
H) if the current iteration is not the first iteration, fixing the cells in said path as the cells selected in said optimization process and selecting shorter connection lengths for said wires in said path which will cause said path to meet all timing and/or power constraints and add the cells and wires of said path to said list of cells and wires in said netlist which are fixed and exporting a parasitic budget for each wire on said path;
I) determining if all paths whose cells and wires are not already fixed (non fixed paths) have been processed in the current iteration;
J) if not all non fixed paths have been processed, returning to step A) and repeating the steps of said iteration starting from step A);
K) if all non fixed paths have been processed in the current iteration, incrementing an iteration number, selecting a new higher level for said parasitic capacitance loading assumption and repeating the process starting at step A) for all paths defined by said netlist which have not had their cells fixed and wires fixed in length using said new higher parasitic capacitance loading assumption for all wires in a path so selected.
